(19) United States
(12) Patent Application Publication
(10) Pub. No.: US 2024/0309835 A1
(43) Pub. Date: Sep. 19, 2024

(54) ROLLER TAPPET ASSEMBLY

(71) Applicant: PHINIA DELPHI LUXEMBOURG SARL, Belvaux (LU)

(72) Inventors: Christopher MCCRINDLE, Gillingham (GB); Diego GUERRATO, Gillingham Kent (GB); Abdul AZIZ, Rainham Kent (GB)

(21) Appl. No.: 18/576,971

(22) PCT Filed: Jun. 20, 2022
(86) PCT No.: PCT/EP2022/066750

§ 371 Date: Jan. 5, 2024

(30) Foreign Application Priority Data
Jul. 6, 2021 (GB) 2109774.6

(51) Int. Cl. F02M 59/10; F02M 63/00; F04B 1/0426; F04B 53/18

(52) U.S. Cl. CPC F02M 59/102; F02M 63/0001; F04B 1/0426; F04B 53/18

(57) ABSTRACT

A roller tappet assembly for a reciprocating pump comprises: a tappet body; a pin element comprising: first and second opposing end portions that engage respective formations in the tappet body to retain the pin element, and a bearing portion, extending between the first and second end portions, for supporting a cam rider arrangement. The cam rider arrangement is supported on the bearing portion of the pin element so that, in use, the reciprocating pump is cyclically loaded and unloaded as an outer surface of the cam rider arrangement interfaces with a rotating camshaft. At least one of: the bearing portion of the pin element; and/or an inner surface of the cam rider arrangement; comprises one or more recessed formations for supporting hydrodynamic lubrication between the cam rider arrangement and the pin element as the bearing portion bends during the loading cycle.

### FIELD OF THE INVENTION

This invention relates to a roller tappet assembly for a reciprocating pump. Aspects of the invention also relate to a reciprocating pump for a fuel injection system.

### BACKGROUND TO THE INVENTION

Fuel injection systems are used to introduce high pressure fuel into the combustion chambers of an internal combustion engine, such as a diesel engine. In a popular arrangement, the fuel injection system delivers fuel to the engine via a set of fuel injectors that are supplied with fuel from a pressurised accumulator, known as a common rail. The fuel in the common rail is typically pressurised by a high-pressure reciprocating pump, which includes a piston or plunger that is driven in a reciprocating linear motion inside a compression chamber, repeating successive pumping and filling strokes. During the filling stroke, a volume of fuel is pressurised and added to the common rail. During the filling stroke, the volume of fuel is replenished as the piston expands the available volume in the compression chamber.

The reciprocating linear motion of the piston is driven by the rotation of an abutting camshaft that features a suitably shaped cam for displacing the piston in a reciprocating motion as the camshaft rotates. It is known to use a tappet assembly on the end of the piston to convert the rotating motion of the camshaft into linear motion of the piston in an efficient manner. For example, a roller tappet assembly may be used, which provides a rotatable roller element on the end of the piston that effectively rides the rotating cam, minimising friction at the interface and smoothly transferring the cyclical load to the piston.

However, the loads exerted on the piston and the tappet assembly can be large enough to cause wear and degradation of the tappet assembly, particularly during the pumping stroke of the reciprocating pump, ultimately leading to failure.

It is against this background that the invention has been devised.

### SUMMARY OF THE INVENTION

According to an aspect of the invention there is provided a roller tappet assembly for a reciprocating pump. The roller tappet assembly comprises a tappet body and a pin element comprising first and second opposing end portions that engage respective formations in the tappet body to retain the pin element, and further comprising a bearing portion, extending between the first and second end portions, for supporting a cam rider arrangement; and said cam rider arrangement supported on the bearing portion of the pin element so that, in use, the reciprocating pump is cyclically loaded and unloaded as an outer surface of the cam rider arrangement interfaces with a rotating camshaft. At least one of the bearing portion of the pin element and/or an inner surface of the cam rider arrangement comprises one or more recessed formations for supporting hydrodynamic lubrication between the cam rider arrangement and the pin element as the bearing portion bends during the loading cycle.

In particular, the roller tappet assembly advantageously includes one or more recessed formations that are formed on the bearing portion of the pin element, and/or an inner surface of the cam rider arrangement, so that a working clearance is maintained by a film of lubricant therebetween as the load increases, i.e. so that a minimum thickness of lubricant is maintained between the pin element and the cam rider arrangement for providing a working clearance during the loading cycle. In this manner, the working clearance is maintained throughout the operation of the reciprocating pump as successive pumping and filling strokes are completed.

Consequently, bearing pressures, and friction, between the pin element and the supported cam rider arrangement may be reduced to increase the load capacity and fatigue life of the pin element.

It shall be appreciated that by supporting hydrodynamic lubrication between the cam rider arrangement and the pin element, the recessed formations may provide a more uniform gap between interfacing surfaces of the pin element and the cam rider arrangement or otherwise support greater conformity between the interfacing surfaces. Consequently, a film of lubricant is retained between the cam rider arrangement and the pin element, urging the pin element and the cam rider arrangement apart and maintaining a working clearance.

Optionally, the one or more recessed formations comprise formations on the bearing portion, adjacent to the first and/or second end portions of the pin element. In an example, the cam rider arrangement may be supported on the bearing portion, extending coaxially to the pin element, from a first end to a second end, and the one or more recessed formations may comprise formations on the bearing portion arranged in alignment with the first and/or second ends of the cam rider arrangement. In this manner, the recessed formations retain a sufficient volume of lubricant for maintaining clearance between the pin element and respective edges presented by the first and second ends of the cam rider arrangement.

Optionally, the one or more recessed formations comprise one or more circumferential grooves defined in the bearing portion.

In an example, the one or more recessed formations may extend axially and circumferentially to define a barrel-shaped bearing portion. Advantageously, a compressed surface of the barrel-shaped bearing portion may therefore be flattened under loading to provide a more conformal interface with the cam rider arrangement.

Optionally, the first and/or second end portions of the pin element define respective shoulders adjacent to the one or more recessed formations on the bearing portion.

Optionally, the cam rider arrangement extends coaxially to the pin element, from a first end to a second end, and wherein the one or more recessed formations comprise formations on the inner surface of the cam rider arrangement, at the first end and/or the second end of the cam rider arrangement. For example, the formations on the inner surface may extend circumferentially to define a chamfer, a bevel, or a cut-away, at the first end and/or the second end of the cam rider arrangement.

Optionally, the one or more recessed formations extend axially and circumferentially to define a convex inner surface of the cam rider arrangement.

The convex inner surface may provide greater conformity to a compressed surface of the bearing portion during the loading cycle.

In an example, the one or more recessed formations have a depth corresponding to the deflection of the bearing portion during the loading cycle. Preferably, the one or more recessed formations may having a maximum depth corresponding to the maximum deflection of a mid-point of the bearing portion during the loading cycle.

The one or more recessed formations may, for example, have a depth of more than, or equal to, 5 μm. The one or more recessed formations may, for example, have a depth of less than, or equal to, 10 μm.

Optionally, the cam rider arrangement comprises a bush element supported on the pin element and a cam rider element, for interfacing with the rotating camshaft, supported on the bush element.

Optionally, the cam rider arrangement comprises a cam rider element, for interfacing with the rotating camshaft, supported on the pin element.

According to another aspect of the invention there is provided a reciprocating pump of a fuel delivery system comprising a roller tappet assembly according to a previous aspect of the invention.

### BRIEF DESCRIPTION OF THE DRAWINGS

In order that the invention may be more readily understood, preferred non-limiting embodiments thereof will now be described, by way of example only, with reference to the accompanying drawings, in which like features are assigned like reference numbers, and in which:

FIG. 1 schematically illustrates an example of a fuel injection system for an internal combustion engine;

FIG. 2 illustrates a cross-sectional view of an example roller tappet assembly for use in a reciprocating pump of the fuel injection system shown in FIG. 1;

FIG. 3 illustrates a cross-sectional view of the roller tappet assembly shown in FIG. 2 during the loading cycle of the reciprocating pump;

FIG. 4 illustrates a cross-sectional view of an example roller tappet assembly, in accordance with an embodiment of the invention, for use in the reciprocating pump of the fuel injection system shown in FIG. 1;

FIG. 5 illustrates a cross-sectional view of an example pin element, in accordance with an embodiment of the invention, of the roller tappet assembly, shown in FIG. 4;

FIG. 6 illustrates a cross-sectional view of the roller tappet assembly, shown in FIG. 4, during the loading cycle of the reciprocating pump;

FIG. 7 illustrates a cross-sectional view of an example pin element, in accordance with an embodiment of the invention, of the roller tappet assembly, shown in FIG. 4; and

FIG. 8 illustrates a cross-sectional view of the pin element, shown in FIG. 7, during the loading cycle.

### DETAILED DESCRIPTION OF EMBODIMENTS OF THE INVENTION

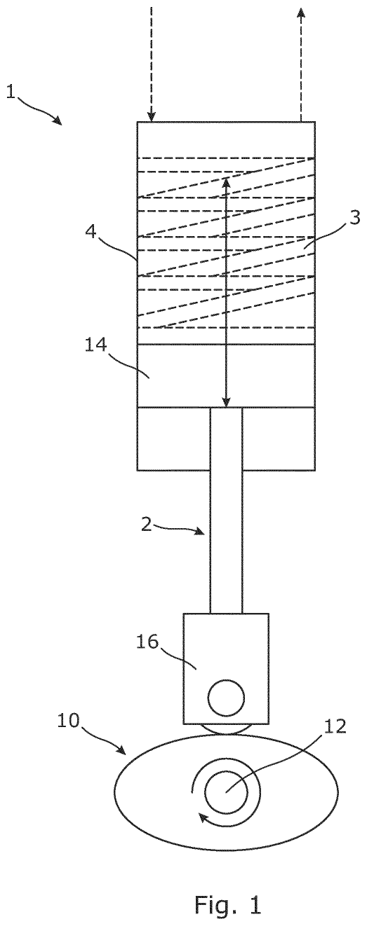

To provide context for the invention, FIG. 1 shows a portion of a pump 1 for a fuel injection system in simplified schematic form. The pump 1 is configured to deliver a supply of pressurised fuel to an accumulator, such as a common fuel rail (not shown).

The pump 1 takes the form of a reciprocating pump 1 operated by the rotation of an abutting camshaft 10, which may be driven by connection to an engine driveshaft for example. The reciprocating pump 1 includes a compression chamber 4 and a piston arrangement 2 configured to move within the compression chamber 4 in a reciprocating linear motion. In particular, the piston arrangement 2 is arranged to move in a first direction, during a pumping stroke, to pressurise a volume of fuel inside the combustion chamber 4 for delivery to the accumulator and subsequently to travel in an opposing second direction, during a filling stroke, to increase the volume of the compression chamber 4 allowing for the volume of fuel to be replenished.

For this purpose, the piston arrangement 2 may include a piston 14 arranged to travel within the compression chamber 4 and a roller tappet assembly 16, also known as a lifter, that extends from an end of the piston 14 for interfacing with the rotating camshaft 10.

As shown in FIG. 1, the roller tappet assembly 16 may be urged into abutting contact with the camshaft 10 by a biasing means, such as the spring 3 (shown by dashed lines), and the roller tappet assembly 16 may be configured to ride a cam member of the camshaft 10 as the camshaft 10 rotates about the longitudinal axis 12. In this manner, the piston arrangement 2 is displaced to produce the reciprocating linear motion that pressurizes the fuel as the camshaft 10 rotates. During the pumping stroke, the piston arrangement 2 is displaced in the first direction against the biasing force of the spring 3 and, during the subsequent filling stroke, the force of the camshaft 10 is alleviated and the spring 3 urges the piston arrangement 2 to move in the opposing direction, expanding the volume of the compression chamber 4.

It shall be appreciated that the piston arrangement 2 is therefore subjected to a cyclical compressive load during the operation of the pump 1. The compressive load increases to a maximum during the pumping stroke and reduces to a minimum during the filling stroke. The exact location of the maximum and minimum loads will depend on the particular configuration of the pump. However, by way of example, the compressive load may increase to a maximum load towards the end of the pumping stroke, when fuel is introduced to the accumulator and the spring 3 is compressed, and the compressive load may reduce to a minimum load towards the end of the filling stroke. In this manner, the piston arrangement 2 is cyclically loaded and unloaded as the camshaft 10 rotates.

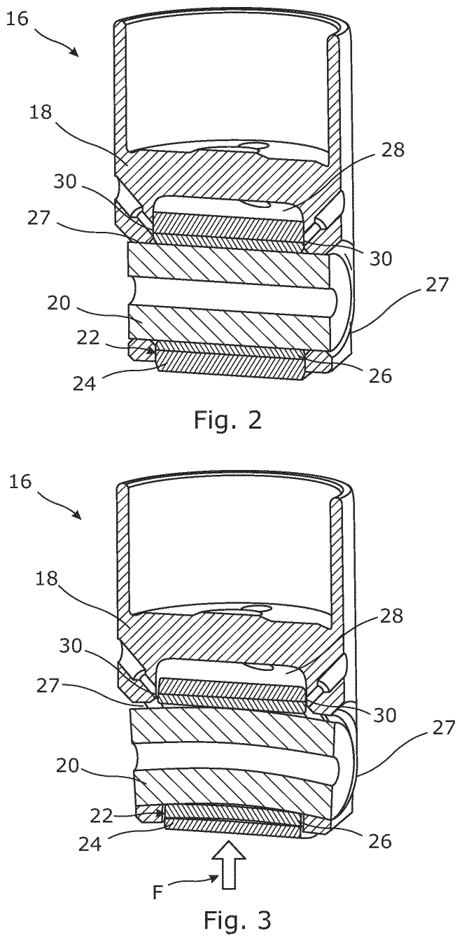

However, during the loading cycle, the compressive load generated can lead to failure of the roller tappet assembly 16, as shall now be discussed in more detail with additional reference to FIGS. 2 and 3.

FIG. 2 shows a cross-sectional view of an example roller tappet assembly 16 in the form of a conventional Pin, Bush, Roller Tappet (PBRT) 16, featuring a tappet body 18, a pin element 20 and a cam rider arrangement 22.

The cam rider arrangement 22 takes a conventional form in this example and includes a roller element 24 for interfacing with the rotating camshaft 10 and a bush element 26, supported on the pin element 20, for rotationally mounting the roller element 24.

The pin element 20 takes the form of a cylindrical rod, which passes through a central bore of the bush element 26 and engages retaining formations on the tappet body 18, such as a pair of opposing holes 27, thereby supporting the cam rider arrangement 22 in a recess 28 of the tappet body 18. It shall be appreciated that both the bush element 26 and the roller element 24 are therefore free to rotate on the pin element 20 within the recess 28.

The recess 28 of the tappet body 18 is provided with a supply of lubricant, for example via the lubrications ports 30 shown in FIG. 2. In this manner, a hydrodynamic lubrication regime may be established, with a film of lubricant being maintained between each pair of interfacing elements to support a working clearance therebetween. The film of lubricant serves to provide substantially uniform load application from the cam rider arrangement 22 to the pin element 20.

In this manner, the cam rider arrangement 22 is free to rotate on the pin element 20 and rides the camshaft 10 as the camshaft 10 rotates, transferring the rotation of the camshaft 10 into linear displacement of the piston arrangement 2.

However, following finite element analysis with combined bearing hydraulic analysis, the inventors have found that, as the compressive load increases during the loading cycle, local deformations of the pin element 20 produce a non-conformal interface between the pin element 20 and the cam rider arrangement 22. In particular, a non-uniform gap forms between the pin element 20 and the cam rider arrangement 22, producing pinch points along the interface, which disrupt the hydrodynamic film. The working clearance is therefore removed and the film disruption gives rise to a non-uniform pressure distribution and the risk of metal-to-metal contact, as shall now be described in more detail with reference to FIG. 3. FIG. 3 illustrates the deformation of the pin element 20 during the loading cycle, and shows a cross-sectional view of the PBRT 16. It shall be appreciated that the proportions of the deformation have been exaggerated in FIG. 3 to better illustrate the issue.

The abutting force of the camshaft 10 is illustrated schematically by the arrow F, which acts on the cam rider arrangement 22 and, in turn, forces the cam rider arrangement 22 against a bearing portion of the pin element 20, extending between the supported ends of the pin element 20.

The force of the camshaft 10 is therefore applied to the bearing portion of the pin element 20 and resisted at the supported ends of the pin element 20. Hence, the applied load introduces a bending moment at the bearing portion.

As the load increases during the pumping stroke, the bending moment increases, causing the bearing portion of the pin element 20 to deflect, as shown in FIG. 3. The deflection shown in FIG. 3 is exaggerated, but may typically be between 5 and 10 μm, for example.

In order for hydrodynamic lubrication to be maintained, the gap between the interfacing components must be sufficient to retain a stable film of lubricant, i.e. a minimum film thickness. However, the deflected shape of the pin element 20 is non-conforming to the cylindrical inner surface of the bush element 26. Consequently, as the load increases, and the pin element 20 bends to a greater extent, the radial gap between the pin element 20 and the bush element is distorted and pinch points form, for example at the ends of the bush element 26, in concentrated regions where contact may occur. The gap and the hydrodynamic film thickness is significantly reduced in such concentrated regions, giving rise to large bearing pressures toward the ends of the bush element 26 and significantly reducing the load capacity of the pin element 20, ultimately leading to a lower failure load.

To a lesser extent, a similar effect may also be seen at the interface between the bush element 26 and the roller element 24, leading to increased bearing pressures between the bush element 26 and the roller element 24 and, hence, reduced load capacity.

Hence, as the compressive load increases during the loading cycle, the bending of the pin element 20 has the effect of limiting the load capacity and component life of the PBRT 16. Additionally, although the problem has been exemplified in relation to a pin, bush, roller tappet, it shall be appreciated that Pin Roller tappets, in general, will have the same limitations due to bending of the pin and the distortion of the interfacing surfaces (e.g. between the pin and cam rider elements).

Embodiments of the invention relate to a roller tappet assembly for mitigating such issues. In particular, the roller tappet assembly of the present invention includes a tappet body, a cam rider arrangement for interfacing with a rotating camshaft, and a pin element for rotationally mounting the cam rider arrangement on the tappet body.

Advantageously, the roller tappet assembly includes one or more recessed formations on the interfacing surfaces of the pin element and/or the cam rider arrangement, that support hydrodynamic lubrication between the cam rider arrangement and the pin element as the compressive load increases during the loading cycle and the pin element bends.

In particular, one or more recessed formations are formed on the bearing portion of the pin element, and/or an inner surface of the cam rider arrangement, so that a gap extending between the interfacing surfaces is more uniform at the end of the loading cycle than otherwise provided in the absence of the recessed formations.

Such recessed formations may provide a more uniform gap by removing pinch points at the ends of the cam rider arrangement or otherwise supporting greater conformity between the interfacing surfaces. In this manner, the recessed formations support hydrodynamic lubrication, maintaining a film of lubricant (i.e. a minimum film thickness) between the cam rider arrangement and the pin element, and providing a working clearance therebetween, as the pin element bends.

Consequently, bearing pressures, and friction, between the pin element and the supported cam rider arrangement may be reduced to increase the load capacity and fatigue life of the pin element.

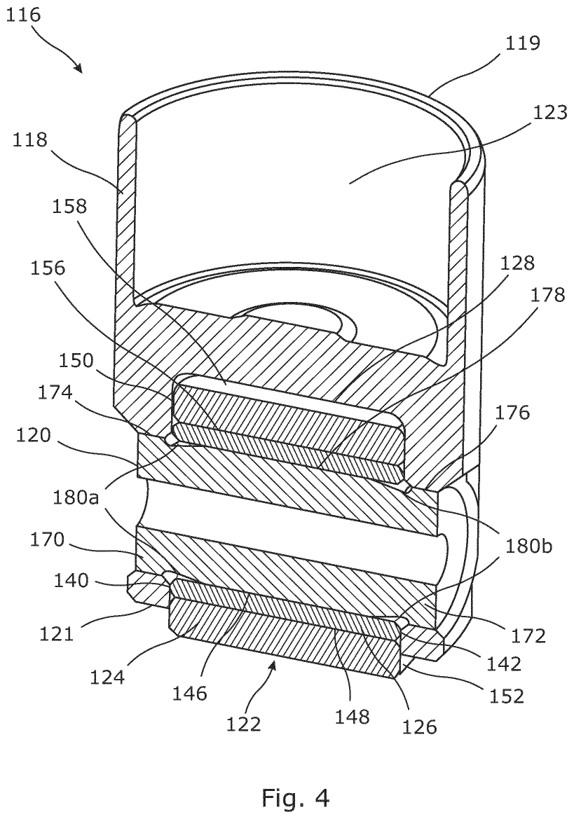

Examples of a roller tappet assembly in accordance with an embodiment of the invention are provided in FIGS. 4 to 8, which shall now be described in more detail. It should be noted that, for the sake of simplicity, counterpart features of each example are assigned similar reference numbers, but incremented by 100 moving from one example to the next.

Furthermore, the roller tappet assemblies described herein are intended for use in a reciprocating pump of a fuel injection system. However, it should be appreciated that the roller tappet assemblies may also be suitable for uses in reciprocating pumps of other fluid power systems.

FIG. 4 shows a cross-sectional view of an example roller tappet assembly 116, in accordance with an embodiment of the invention.

The roller tappet assembly 116 takes the form of a PBRT 116, in this example, but may take the form of a pin roller tappet, in other examples. The PBRT 116 features a tappet body 118, a pin element 120 and a cam rider arrangement 122. The cam rider arrangement 122 includes a roller element 124 for interfacing with the rotating camshaft 10 and a bush element 126 for rotationally mounting the roller element 124 on the supporting pin element 120.

In this example, the tappet body 118 is shown to take a cylindrical form and extends from a first end 119 to a second end 121. The first end 119 includes an opening 123 for receiving the piston 14 and the second end 121 includes a recess 128 for receiving the cam rider arrangement 122. In this manner, the tappet body 118 may provide a housing for the cam rider arrangement 122 and the tappet body 118 may be attached to, or otherwise received on an end of, the piston 14. The piston-tappet connection is not described in detail here to avoid obscuring the invention but it shall be appreciated that, in other examples, the tappet body 118 could alternatively be formed integrally with the piston 14 or otherwise supported between an end of the piston 14 and the rotating camshaft 10.

Although not shown in FIG. 4, the tappet body 118 also includes first and second lubrication ports that extend into the recess 128 for providing a supply of lubricant to the pin element 120 and the cam rider arrangement 122. In this manner, a hydrodynamic lubrication regime may be established, with a working clearance being maintained by a film of lubricant between each pair of interfacing components. In particular, a working clearance may be maintained by a film of lubricant between the cam rider arrangement 122 and the supporting pin element 120, as well as between the bush element 126 and the roller element 124.

The roller element 124 and the bush element 126 each take a conventional form in this example. The bush element 126 extends from a first end 140 to a second end 142, and features a central bore that extends through the bush element 126 to define an inner surface 146 for interfacing with the supporting pin element 120.

The bush element 126 also features an outer surface 148, that extends between the first and second ends 140, 142 for receiving, and rotationally mounting, the roller element 124. In this example, the inner and outer surfaces 146, 148 of the bush element 126 are cylindrical, or substantially cylindrical, without any of the recessed formations that may be present in other embodiments, as shall be described in more detail in the following description.

The roller element 124 is equal in length to the bush element 126 and similarly extends from a first end 150 to a second end 152, with a central bore extending through the roller element 124 to define an inner surface 156 that interfaces with the outer surface 148 of the bush element 126. The roller element 124 also features an outer surface 158 for interfacing with the rotating camshaft 10. Again, in this example, the inner and outer surfaces 156, 158 of the roller element 124 are cylindrical, or substantially cylindrical, without any of the recessed formations that may be present in other embodiments, as shall be described in more detail in the following description.

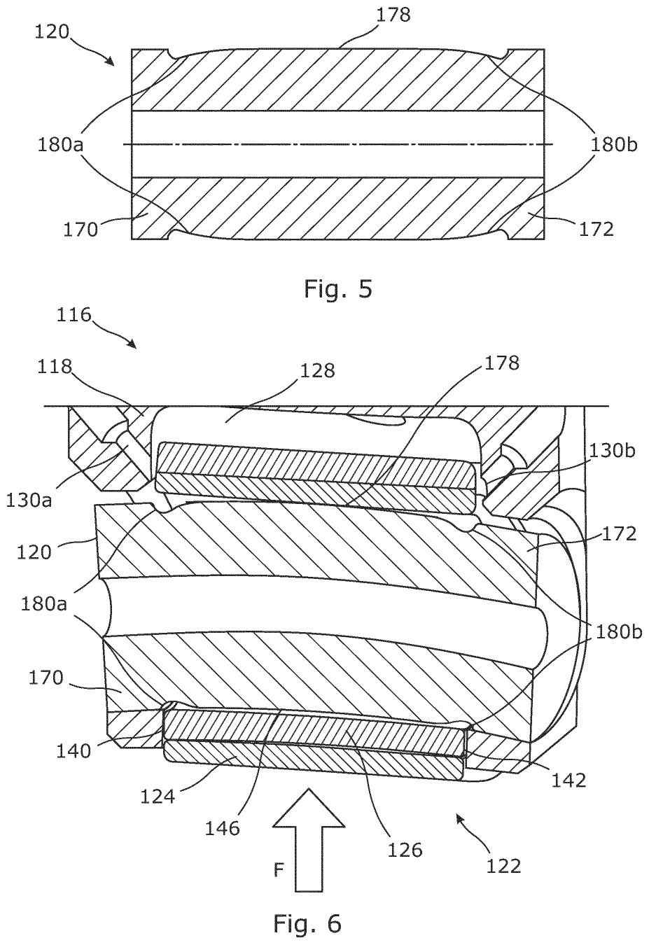

The pin element 120 takes the form of a generally cylindrical rod in this example and extends from a first end portion 170 to a second end portion 172, with an axially extending central bore that is best shown with additional reference to the cross-sectional view of the pin element 120, shown in FIG. 5.

The first and second end portions 170, 172 are configured to engage respective formations in the tappet body 118 to retain the pin element 120 against the pumping loads exerted by the camshaft 10. For example, the first and second end portions 170, 172 may each define cylindrical ends of the pin element 122, as shown in FIGS. 4 and 5, that respectively engage a first hole 174 and an opposing second hole 176 of the tappet body 118. As shown in FIG. 4, the first and second holes 174, 176 may be defined in opposing sidewalls of the recess 130 such that the pin element 120 extends across the recess 130 in assembly.

The pin element 120 is also shown to include a bearing portion 178 for supporting the cam rider arrangement 122, which extends between the first and second end portions 170, 172. The bearing portion 178 is configured to interface with the inner surface 146 of the bush element 126 and includes one or more recessed formations 180a-b for supporting hydrodynamic lubrication between the cam rider arrangement 122 and the pin element 120, as shall be described in more detail below.

In the example shown in FIGS. 4 and 5, the one or more recessed formations 180a-b include a first recessed groove 180a, adjacent to the first end portion 170, and a second recessed groove 180b, adjacent to the second end portion 172, each extending circumferentially around the bearing portion 178. In this manner, the first and second end portions 170, 172 effectively define respective shoulders adjacent to the bearing portion 178, due to the relatively large radii of the first and second end portions 170, 172.

In this example, each of the first and second recessed grooves 180a-b has a depth, relative to an adjacent portion of the bearing portion 178 (such as a cylindrical mid-portion of the bearing portion 178), that corresponds to the anticipated deflection of the bearing portion 178 at the end of the loading cycle. For context, each of the first and second grooves 180a-b may therefore have a depth of at least 1 micrometre, and preferably more than, or equal to, 5 micrometres, for example.

The depth of each of the first and second recessed grooves 180a-b may also be less than, or equal to, 50 micrometres, preferably less than, or equal to, 20 micrometres, and more preferably, less than, or equal to, 10 micrometres, for example.

As best shown in FIG. 4, in this example, each of the first and second recessed grooves 180a-b extends axially from a respective one of the first and second end portions 170, 172, towards a mid-point of the bearing portion 178 to accommodate a respective end 140, 142 of the bush element 126. That is, the first and second recessed grooves 180a-b extend along sufficient lengths of the bearing portion 178 to ensure that, in assembly, each end 140, 142 of the bush element 126 is positioned in alignment with a respective one of the first and second recessed grooves 180a-b.

Each of the first and second recessed grooves 180a-b may take various suitable shapes for this purpose. In this example, each of the first and second recessed grooves 180a-b includes a curved fillet section extending axially from a respective one of the first and second end portions 170, 172 to a trough of the respective groove 180a-b, and a smooth tapered section that extends away from the trough, gradually increasing the radius of the bearing portion 178 towards a cylindrical mid-portion of the bearing portion 178, as best shown in FIG. 5. The first and second recessed grooves 180, 182 may be substantially identical to one another, as shown in this example, and symmetric about an axial mid-plane of the pin element 120.

In assembly, the cam rider arrangement 122 is inserted into the recess 128 provided in the tappet body 118 and the pin element 120 passes through the central bore of the bush element 26 to engage the retaining formations 174, 176 of the tappet body 118, as shown in FIG. 4. In this manner, the cam rider arrangement 122 is retained in the recess 128 and rotationally mounted on the bearing portion 178 of the pin element 120 so that the bush element 126 and the roller element 124 are free to rotate, within the recess 128, on the pin element 120. It shall be appreciated that the cam rider arrangement 122 is received in the recess 128 with a small working clearance between the ends 140,142 of the bush element 126 and the sidewalls of the recess 128, axially retaining the cam rider arrangement 122 on the pin element 120. Significantly, the first and second lubrication ports (not shown in FIG. 4) are therefore able to provide the supply of lubricant to establish a hydrodynamic lubrication regime between the cam rider arrangement 122 and the supporting pin element 120, and the first and second ends 140, 142 of the bush element 126 are positioned in alignment with respective ones of the first and second recessed grooves 180a-b of the pin element 120.

In use, the cam rider arrangement 122 rotates freely on the pin element 120 and the outer surface 158 of the roller element 124 interfaces with the rotating camshaft 10 to transfer the rotation of the camshaft 10 into linear displacement of the piston arrangement 2.

Now considering the loading cycle in more detail, FIG. 6 illustrates the deformation of the pin element 120 during the loading cycle, showing a cross-sectional view of the roller tappet assembly 116. Again, it shall be appreciated that the proportions of the deformation have been exaggerated to better illustrate the component strains.

The abutting force of the camshaft 10 is illustrated schematically once more by the arrow, F, which acts on the cam rider arrangement 122 and, in turn, forces the cam rider arrangement 122 against the bearing portion 178 of the pin element 120.

The force of the camshaft 10 is therefore resisted at the supported end portions 170, 172 of the pin element 120 and applied to the bearing portion 178 of the pin element 120. Hence, the applied load introduces a bending moment in the bearing portion 178 of the pin element 120.

As the load increases during the pumping stroke, the bending moment increases, causing the bearing portion 178 of the pin element 120 to deflect, as in the previous example. For context, the deflection may typically be between 5 and 10 μm, for example.

However, in this example, the first and second recessed grooves 180a-b of the bearing portion 178 accommodate the first and second ends 140, 142 of the bush element 126 as the bearing portion 178 is deflected. In particular, the first and second recessed grooves 180a-b are suitably shaped and sized such that they retain a sufficient volume of lubricant for maintaining clearance between the pin element 120 and respective edges presented by the first and second ends 140, 142 of the bush element 126.

In this manner, the pinch points encountered in the previous example are alleviated and the radial gap between the pin element 120 and the bush element 126 is made more uniform along the interfacing surfaces, such that a film of lubricant (supplied by the lubrication ports 130a-b) can be retained between the pin element 120 and the bush element 126, supporting a working clearance. Hence, as the compressive load increases during the during the loading cycle, the first and second recessed grooves 180a-b promote, or otherwise support, hydrodynamic lubrication between the cam rider arrangement 122 and the pin element 120 as the bearing portion 178 bends. The hydrodynamic lubrication creates a more uniform, and lower, bearing pressure, increasing the load capacity and fatigue life of the PBRT 116. The benefits of reduced bearing pressure may also be seen at the interface between the bush element 126 and the roller element 124, leading to reduced wear and friction between those components.

It is envisaged that the roller tappet assembly 116 of the present invention will therefore provide a higher load capacity, allowing for higher pumping loads and increased fuel pressures.

It will be appreciated by a person skilled in the art that the invention could be modified to take many alternative forms to that described herein, without departing from the scope of the appended claims.

For example, it shall be appreciated that recessed formations, supporting hydrodynamic lubrication between the pin element and the bush element by alleviating the contact with the ends of the bush element, may be provided to equivalent effect on the inner surface of the bush element in other examples.

For example, each of the first and second ends of the bush element may be suitably chamfered, bevelled, or cut-away, at the inner surface such that pinch points at the edges are alleviated and a film of lubricant may be maintained between the pin element and the bush element, as the pin element bends.

Furthermore, in other examples, the recessed formations on the bearing portion of the pin element may take other suitable forms that may support hydrodynamic lubrication by providing greater conformity between the interfacing surfaces of the pin element and the cam rider arrangement as the pin element bends.

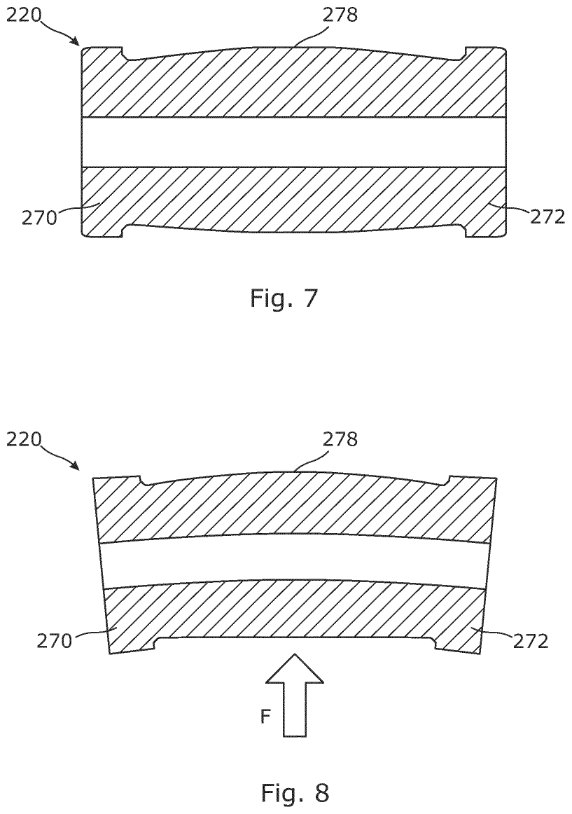

For example, FIG. 7 shows a cross-sectional view of an alternative pin element 220, in accordance with an embodiment of the invention, that may be utilised in the roller tappet assembly 116.

In this example, the pin element 220 is substantially as described previously, however the recessed formations on the bearing portion 278 extend axially from the first and second end portions 270, 272 to the mid-point of the bearing portion 278, defining a smoothly curved and barrel-shaped bearing portion 278.

In particular, the recessed formations may define a barrel-shaped bearing portion 278, having a maximum radius at a mid-point of the bearing portion 278 and narrowing away from the mid-point towards respective ends of the bearing portion 278, where curved fillets may join the bearing portion 178 to the first and second end portions 270, 272. The curved fillets may serve to minimise the stress concentration at the shoulders, which are effectively defined by the relatively large radius of the pin element 220 at the first and second end portions 270, 272.

In this example, the curvature of the barrel-shaped bearing portion 278 corresponds to the deflection of the pin element 220 during the loading cycle, for example such that a compressed surface of the bearing portion is substantially flattened at the end of the loading cycle, i.e. when the compressive load is largest.

In particular, the curvature of the bearing portion 278 may be such that the difference between the minimum and maximum radii of the bearing portion 278 corresponds to the deflection of the bearing portion 278 under the maximum compressive load. For example, the difference between the minimum and maximum radii of the bearing portion 278 may be at least 1 micrometre, and preferably more than, or equal to, 5 micrometres. The difference between the minimum and maximum radii of the bearing portion 278 may, for example, be less than, or equal to, 50 micrometres, preferably less than, or equal to, 20 micrometres, and more preferably, less than, or equal to, 10 micrometres.

In this manner. the barrel-shape of the bearing portion 278 supports hydrodynamic lubrication between the cam rider arrangement 122 and the pin element 220 as the compressive load increases during the loading cycle, as shall now be described with further reference to FIG. 8.

FIG. 8 illustrates the deformation of the pin element 220 during the loading cycle, showing a cross-sectional view of the pin element 220. Again, it shall be appreciated that the proportions of the deformation have been exaggerated to better illustrate the mechanics.

The abutting force of the camshaft 10 is illustrated schematically by the arrow, F, which acts on the cam rider arrangement 122 and, in turn, forces the cam rider arrangement 122 against the bearing portion 278 of the pin element 220.

In this example, as the pin element 220 bends during the loading cycle, the curvature of a compressed surface of the bearing portion 278 reduces, forming a more cylindrical surface that conforms to the cylindrical inner surface 146 of the bush element 126 to a greater extent. In FIG. 8, this is shown by the straightened lower surface of the bearing portion 278, against which the cam rider arrangement 122 bears. In this manner, the gap between the pin element 220 and the bush element 126 is made more uniform, supporting hydrodynamic lubrication between the pin element 220 and the bush element 126 and maintaining a working clearance therebetween.

It shall be appreciated that, in this example, the gap between the pin element 220 and the bush element 126 is actually more uniform at the end of the loading cycle, where the compressive load is largest, compared to the end of the unloading cycle, i.e. where the compressive load is smallest. This has the effect of minimising the bearing pressure during the pumping stroke and increasing the load capacity of the PBRT 116. It shall also be appreciated that it is considered more important to minimise bearing pressures by supporting conformal interfacing surfaces, and hydrodynamic lubrication, at the end of the loading cycle, where the compressive load is largest, as opposed to the end of the unloading cycle, where the reduced load is less likely to disrupt the film of lubricant.

In still further examples, it shall be appreciated that the interfacing surfaces of the pin element and the cam rider arrangement may take other complementary shapes, defined by one or more recessed formations, that support hydrodynamic lubrication of the interface as the compressive load increases during the loading cycle. For example, in an equivalent manner to the example above, recessed formations may extend axially and circumferentially from the first and second ends 140, 142 of the bush element 126, instead of the pin element 220, to define a convex inner surface 146, achieving the same effect of supporting hydrodynamic lubrication between the pin element 120 and the bush element 126 during the loading cycle.

Additionally, although the examples described above relate to a pin, bush, roller tappet, it shall be appreciated that the same arrangements may serve to minimise bearing pressures in a pin roller tappet, i.e. with one or more recessed formations being formed in the interfacing surfaces of the pin and roller elements. Further, in the examples provided above, the roller element is free to rotate relative to the bush element and the bush element is, in turn, free to rotate relative to the pin element. However, in other examples, it shall be appreciated that the bush element and/or the roller element may be rotationally fixed relative to one another and/or relative to the pin element.

### REFERENCES USED

1—Pump
2—Piston arrangement
3—Spring
4—Compression chamber
10—Camshaft
12—Longitudinal axis of rotation
14—Piston
16—Roller tappet assembly (PBRT)
20—Pin element
22—Cam rider arrangement
24—Roller element
26—Bush element
27—Pair of opposing holes
28—Recess
30—Lubrication ports
116—PBRT
118—Tappet body
119—First end of tappet body
120—Pin element
121—Second end of tappet body
122—Cam rider arrangement
123—Opening of tappet body
124—Roller element
126—Bush element
128—Recess of tappet body
130a-b—First and Second lubrication ports
140—First end of bush element
142—Second end of bush element
146—Inner surface of bush element
148—Outer surface of bush element
150—First end of roller element
152—Second end of roller element
156—Inner surface of roller element
158—Outer surface of roller element
170—First end portion of pin element
172—Second end portion of pin element
174—First hole in tappet body
176—Second hole in tappet body
178—Bearing portion of tappet body
180a-b—First and second recessed grooves
220—Pin element
270—First end portion of pin element
272—Second end portion of pin element
278—Bearing portion of pin element

1. A roller tappet assembly for a reciprocating pump, the roller tappet assembly comprising:
a tappet body;
a pin element comprising:
first and second opposing end portions that engage respective formations in the tappet body to retain the pin element, and
a bearing portion, extending between the first and second end portions, for supporting a cam rider arrangement; and
said cam rider arrangement supported on the bearing portion of the pin element so that, in use, the reciprocating pump is cyclically loaded and unloaded as an outer surface of the cam rider arrangement interfaces with a rotating camshaft;
wherein at least one of:
the bearing portion of the pin element; and/or
an inner surface of the cam rider arrangement;
comprises one or more recessed formations for supporting hydrodynamic lubrication between the cam rider arrangement and the pin element as the bearing portion bends during the loading cycle.

2. A roller tappet assembly according to claim 1, wherein the one or more recessed formations comprise formations on the bearing portion, adjacent to the first and/or second end portions of the pin element.

3. A roller tappet assembly according to claim 1, wherein the cam rider arrangement is supported on the bearing portion, extending coaxially to the pin element, from a first end to a second end, and wherein the one or more recessed formations comprises formations on the bearing portion arranged in alignment with the first and/or second ends of the cam rider arrangement.

4. A roller tappet assembly according to claim 2, wherein the one or more recessed formations comprise one or more circumferential grooves defined in the bearing portion.

5. A roller tappet assembly according to claim 1, wherein the one or more recessed formations extend axially and circumferentially to define a barrel-shaped bearing portion.

6. A roller tappet assembly according to claim 1, wherein the first and/or second end portions of the pin element define respective shoulders adjacent to the one or more recessed formations on the bearing portion.

7. A roller tappet assembly according to claim 1, wherein the cam rider arrangement extends coaxially to the pin element, from a first end to a second end, and wherein the one or more recessed formations comprise formations on the inner surface of the cam rider arrangement, at the first end and/or the second end of the cam rider arrangement.

8. A roller tappet assembly according to claim 7, wherein the formations on the inner surface extend circumferentially to define a chamfer, a bevel, or a cut-away, at the first end and/or the second end of the cam rider arrangement.

9. A roller tappet assembly according to claim 7, wherein the one or more recessed formations extend axially and circumferentially to define a convex inner surface of the cam rider arrangement.

10. A roller tappet assembly according to claim 1, wherein the one or more recessed formations have a depth corresponding to the deflection of the bearing portion during the loading cycle, preferably having a maximum depth corresponding to the maximum deflection of a mid-point of the bearing portion during the loading cycle.

11. A roller tappet assembly according to claim 10, wherein the one or more recessed formations have a depth of more than, or equal to, 5 μm.

12. A roller tappet assembly according to claim 10, wherein the one or more recessed formations have a depth of less than, or equal to, 10 μm.

13. A roller tappet assembly according to claim 1, wherein the cam rider arrangement comprises a bush element supported on the pin element and a cam rider element, for interfacing with the rotating camshaft, supported on the bush element.

14. A roller tappet assembly according to claim 1, wherein the cam rider arrangement comprises a cam rider element, for interfacing with the rotating camshaft, supported on the pin element.

15. A reciprocating pump of a fuel delivery system comprising the roller tappet assembly of claim 1.
